(19) United States
(12) Patent Application Publication
(10) Pub. No.: US 2019/0215518 A1
(43) Pub. Date: Jul. 11, 2019

(54) HISTOGRAM OF GRADIENT BASED OPTICAL FLOW

(71) Applicant: QUALCOMM Incorporated, San Diego, CA (US)

(72) Inventors: Aravind Alagappan, San Diego, CA (US); Marc Bosch Ruiz, Rockville, MD (US); Yu Liu, Menlo Park, CA (US); Shyamprasad Chikkerur, San Diego, CA (US); Yunqing Chen, Los Altos, CA (US); Tushar Singhal, San Diego, CA (US); Shu Lin, San Diego, CA (US); Kai Wang, San Diego, CA (US); Harikrishna Reddy, San Jose, CA (US)

(21) Appl. No.: 15/866,582

(22) Filed: Jan. 10, 2018

(51) Int. Cl. H04N 19/139; G06T 7/269; H04N 19/53; G06T 7/207

(52) U.S. Cl. CPC H04N 19/139; G06T 7/207; H04N 19/53; G06T 7/269

(57) ABSTRACT

Methods, systems, and devices for motion analysis are described. Generally, the described techniques provide for computationally efficient and accurate motion analysis. A device may identify frames of a video frame sequence having a defined resolution. The device may downscale the frames to generate a plurality of downsampled images each having a resolution lower than the defined resolution. The device may generate a respective histogram vector for each pixel of each downsampled image and each pixel of the original frames. The device may determine a motion vector candidate based at least in part on the histogram vectors. The device may apply a filter to the motion vector candidates to determine a final motion vector and output an indication of motion between the frames of the video frame sequence based at least in part on the final motion vector for each pixel of the second frame.

### BACKGROUND

The following relates generally to motion analysis, and more specifically to histogram of gradient based optical flow.

Motion estimation arises in many different machine vision tasks, such as robotics (including navigation and obstacle avoidance), autonomous vehicles, medical image analysis (including nonrigid motion such as angiography), video compression, etc. When the motion between two or more generally sequential image frames (e.g., two frames of a video frame sequence separated by a small time interval) is relatively smooth, the motion may be described by the optical flow (e.g., defined as the two-dimensional motion field between the two frames). The optical flow may indicate objects in the image which are moving, which direction they are moving, how quickly they are moving, etc. For example, dense optical flow may provide an estimate of motion for all pixels in a video sequence.

In some cases, optical flow analysis may be simplified (e.g., to reduce computational costs and hardware complexity for a device, to improve throughput for the optical flow analysis, etc.). As an example, some optical flow estimation methods may provide information for a block of pixels (e.g., an eight-by-eight block of pixels) rather than every pixel in the video. The accuracy of these estimation methods may be measured by how closely they can estimate both local and global motions for a given video frame sequence. Thus, optical flow techniques may in some cases experience a trade-off between computational costs and accuracy. That is, reduced computational complexity may in some cases be associated with corresponding reductions in accuracy of the optical flow analysis. Improved techniques for motion analysis may be desired.

### SUMMARY

The described techniques relate to methods, systems, devices, or apparatuses that support histogram of gradient based optical flow. Generally, the described techniques provide for accurate motion analysis that may be performed at a reduced computational cost (e.g., compared to brute force implementations). In accordance with the described techniques, a device may perform a multiple-pass low resolution-based motion estimation (e.g., to resolve global motion, low resolution details, lattice details). For example, each pass may be performed at a particular resolution (e.g., in a pyramidal fashion) to progressively refine the motion estimates. Additionally, the described techniques provide for local motion prediction and final optical flow refinement (e.g., by selecting a motion vector candidate from a pool of candidates based on one or more cost functions). The local motion prediction and optical flow refinement may allow for motion estimates for small objects not captured in the low resolution analysis to be recovered. Aspects of the present disclosure further apply to gradient-based adaptive regularization (e.g., to better guide final refinement) and adaptive median filtering (e.g., to remove any motion vector outliers).

A method of motion analysis is described. The method may include identifying a first frame of a video frame sequence and a second frame of the video frame sequence, the first and second frame each having a defined resolution, downscaling the first frame and the second frame to generate a plurality of downsampled images each having a resolution lower than the defined resolution, generating a respective histogram vector for each pixel of each downsampled image and each pixel of the first frame and the second frame, determining a motion vector candidate for each pixel of the second frame based at least in part on the histogram vectors, applying a filter to the motion vector candidates of the second frame to determine a final motion vector for each pixel of the second frame, and outputting an indication of motion between the first frame and the second frame based at least in part on the final motion vector for each pixel of the second frame.

An apparatus for motion analysis is described. The apparatus may include means for identifying a first frame of a video frame sequence and a second frame of the video frame sequence, the first and second frame each having a defined resolution, means for downscaling the first frame and the second frame to generate a plurality of downsampled images each having a resolution lower than the defined resolution, means for generating a respective histogram vector for each pixel of each downsampled image and each pixel of the first frame and the second frame, means for determining a motion vector candidate for each pixel of the second frame based at least in part on the histogram vectors, means for applying a filter to the motion vector candidates of the second frame to determine a final motion vector for each pixel of the second frame, and means for outputting an indication of motion between the first frame and the second frame based at least in part on the final motion vector for each pixel of the second frame.

Another apparatus for motion analysis is described. The apparatus may include a processor, memory in electronic communication with the processor, and instructions stored in the memory. The instructions may be operable to cause the processor to identify a first frame of a video frame sequence and a second frame of the video frame sequence, the first and second frame each having a defined resolution, downscale the first frame and the second frame to generate a plurality of downsampled images each having a resolution lower than the defined resolution, generate a respective histogram vector for each pixel of each downsampled image and each pixel of the first frame and the second frame, determine a motion vector candidate for each pixel of the second frame based at least in part on the histogram vectors, apply a filter to the motion vector candidates of the second frame to determine a final motion vector for each pixel of the second frame, and output an indication of motion between the first frame and the second frame based at least in part on the final motion vector for each pixel of the second frame.

A non-transitory computer-readable medium for motion analysis is described. The non-transitory computer-readable medium may include instructions operable to cause a processor to identify a first frame of a video frame sequence and a second frame of the video frame sequence, the first and second frame each having a defined resolution, downscale the first frame and the second frame to generate a plurality of downsampled images each having a resolution lower than the defined resolution, generate a respective histogram vector for each pixel of each downsampled image and each pixel of the first frame and the second frame, determine a motion vector candidate for each pixel of the second frame based at least in part on the histogram vectors, apply a filter to the motion vector candidates of the second frame to determine a final motion vector for each pixel of the second frame, and output an indication of motion between the first frame and the second frame based at least in part on the final motion vector for each pixel of the second frame.

In some examples of the method, apparatus, and non-transitory computer-readable medium described above, downscaling the first frame and the second frame to generate the plurality of downsampled images comprises downscaling the first frame to generate a first downsampled image having a first resolution and a second downsampled image having a second resolution that may be lower than the first resolution. Some examples of the method, apparatus, and non-transitory computer-readable medium described above may further include processes, features, means, or instructions for downscaling the second frame to generate a third downsampled image having the first resolution and a fourth downsampled image having the second resolution.

Some examples of the method, apparatus, and non-transitory computer-readable medium described above may further include processes, features, means, or instructions for determining a coarse global motion candidate for a given pixel of the fourth downsampled image based at least in part on comparing the histogram vector for the given pixel and the histogram vector for at least one pixel in the second downsampled image.

Some examples of the method, apparatus, and non-transitory computer-readable medium described above may further include processes, features, means, or instructions for applying the global motion candidate for the given pixel of the fourth downsampled image to a corresponding set of pixels of the third downsampled image and refining the coarse global motion candidate to generate a respective fine global motion candidate for each pixel of the corresponding set of pixels based at least in part on the histogram vectors for the third downsampled image and the histogram vectors for the first downsampled image.

Some examples of the method, apparatus, and non-transitory computer-readable medium described above may further include processes, features, means, or instructions for reducing a variance for the fine global motion candidates of the corresponding set of pixels based at least in part on applying a respective cost function to each fine global motion candidate, wherein the cost function comprises a clipping function that limits the variance.

In some examples of the method, apparatus, and non-transitory computer-readable medium described above, generating the respective histogram vector for each pixel of each downsampled image and each pixel of the first frame and the second frame comprises determining a respective gradient for each pixel of each downsampled image and each pixel of the first frame and the second frame. Some examples of the method, apparatus, and non-transitory computer-readable medium described above may further include processes, features, means, or instructions for identifying, for each pixel of each downsampled image and each pixel of the first frame and the second frame, a surrounding region comprising a plurality of neighboring pixels. Some examples of the method, apparatus, and non-transitory computer-readable medium described above may further include processes, features, means, or instructions for dividing the surrounding region into a plurality of non-overlapping sectors each comprising a respective subset of the plurality of neighboring pixels. Some examples of the method, apparatus, and non-transitory computer-readable medium described above may further include processes, features, means, or instructions for computing a sub-vector of histograms for each sector of the plurality of non-overlapping sectors based at least in part on the gradients for the respective subset of the plurality of neighboring pixels. Some examples of the method, apparatus, and non-transitory computer-readable medium described above may further include processes, features, means, or instructions for concatenating the sub-vectors of histograms to generate the histogram vector.

In some examples of the method, apparatus, and non-transitory computer-readable medium described above, computing the sub-vector of histograms for each sector of the plurality of non-overlapping sectors comprises identifying a nominal orientation associated with each histogram, comparing each respective gradient to the nominal orientation of at least one histogram, and apportioning each respective gradient into at least one histogram based at least in part on the magnitude of the respective gradient and the comparison.

In some examples of the method, apparatus, and non-transitory computer-readable medium described above, determining the respective gradient for each pixel comprises computing a horizontal gradient and a vertical gradient for each pixel. Some examples of the method, apparatus, and non-transitory computer-readable medium described above may further include processes, features, means, or instructions for determining a magnitude and an orientation for the respective gradient based at least in part on the horizontal gradient and the vertical gradient.

In some examples of the method, apparatus, and non-transitory computer-readable medium described above, applying the filter to the motion vector candidates of the second frame to determine the final motion vector for each pixel comprises identifying a block variance metric for a region of the second frame surrounding the pixel. Some examples of the method, apparatus, and non-transitory computer-readable medium described above may further include processes, features, means, or instructions for selecting a first median-based filter or a second median-based filter that may be larger than the first median-based filter based at least in part on the block variance metric. Some examples of the method, apparatus, and non-transitory computer-readable medium described above may further include processes, features, means, or instructions for applying the first median-based filter to the motion vector candidates or the second median-based filter to the motion vector candidates.

In some examples of the method, apparatus, and non-transitory computer-readable medium described above, selecting the first median-based filter or the second median-based filter comprises comparing the block variance metric to a threshold and selecting the first median-based filter when the block variance metric is greater than the threshold or select the second median-based filter when the block variance metric is less than the threshold.

### BRIEF DESCRIPTION OF THE DRAWINGS

FIGS. 1A, 1B, and 1C illustrate video frames and a motion vector grid that support histogram of gradient based optical flow in accordance with aspects of the present disclosure.

FIG. 2 illustrates an example of a process flow that supports histogram of gradient based optical flow in accordance with aspects of the present disclosure.

FIG. 3 illustrates an example of a pixel array that supports histogram of gradient based optical flow in accordance with aspects of the present disclosure.

FIG. 4 illustrates an example of a wireless communications system that supports histogram of gradient based optical flow in accordance with aspects of the present disclosure.

FIGS. 5 and 6 illustrate block diagrams of devices that support histogram of gradient based optical flow in accordance with aspects of the present disclosure.

FIGS. 7, 8A, and 8B illustrate methods for histogram of gradient based optical flow in accordance with aspects of the present disclosure.

### DETAILED DESCRIPTION

Optical flow is the pattern of apparent motion of objects, surfaces, and edges in a visual scene (e.g., caused by the relative motion between an observer and the scene, motion of objects within the scene, etc.). Specifically, sequences of ordered image frames (e.g., a video stream) allow the estimation of motion as either instantaneous image velocities or discrete image displacements. In some cases, optical flow may be used to estimate the three-dimensional nature and structure of a given scene, the three-dimensional motion of an object, etc. Optical flow may in some cases experience a trade-off between computational complexity and accuracy. For example, a brute-force implementation in which each pixel of a set of frames is rigorously analyzed in order to determine an optimal motion vector candidate for every pixel may provide accurate results at the cost of large computational complexity. Simplifications which reduce the computational complexity may in some cases reduce the accuracy of the results (e.g., below useful levels). Techniques described herein provide for robust motion analysis in the context of a computationally conservative framework.

In accordance with the described techniques, a device may perform a multiple-pass low resolution-based motion estimation (e.g., to resolve global motion, low resolution details, lattice details, etc.). For example, each pass may be performed at a particular resolution (e.g., in a pyramidal fashion) to progressively refine the motion estimates. The pyramidal search may provide benefits including minimizing search costs, and thus increasing the likelihood of falling into a cost minima while considering large motions between frames such as motion due to viewpoint shift, motion arising from objects moving quickly relative to other objects in a scene (e.g., a car against a static backdrop), etc. Additionally or alternatively, the described techniques may increase the signal-to-noise ratio (SNR) for flat (e.g., homogeneous) pixel blocks in high resolution images. Additionally, the described techniques proved for local motion prediction and final optical flow refinement (e.g., by selecting a motion vector candidate from a pool of candidates based on one or more cost functions). The local motion prediction and optical flow refinement may allow for motion estimates for small objects not captured in the low resolution analysis to be recovered. Aspects of the present disclosure further apply to gradient-based adaptive regularization (e.g., to better guide final refinement) and adaptive median filtering (e.g., to remove any motion vector outliers). Aspects of the disclosure are initially described in the context of video frames, a process flow, and a pixel array. Aspects of the disclosure are further illustrated by and described with reference to apparatus diagrams, system diagrams, and flowcharts that relate to histogram of gradient based optical flow.

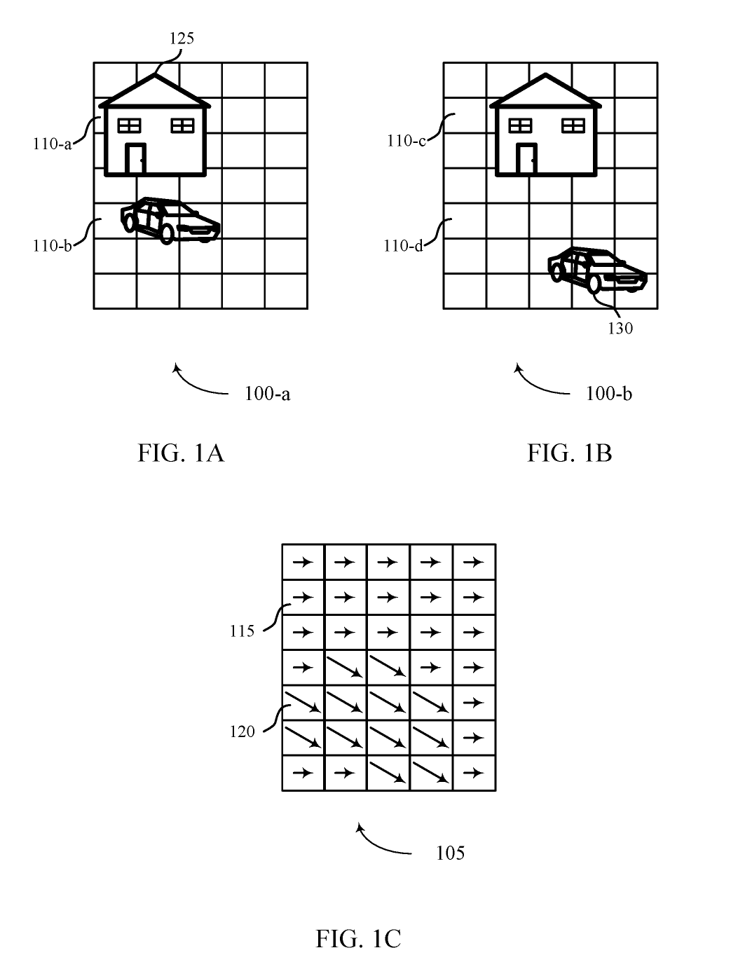

FIGS. 1A, 1B, and 1C illustrate a motion vector grid 105 (illustrated in FIG. 1C) generated based on a comparison of a first frame 100-a (e.g., a reference frame illustrated in FIG. 1A) with a second frame 100-b (e.g., a current frame illustrated in FIG. 1B). For example, first frame 100-a may immediately (e.g., or closely) precede second frame 100-b in a video frame sequence (e.g., a video stream). The video frame sequence may be retrieved from a system memory of a device (e.g., a hard drive), may be received in a communication (e.g., a wireless communication) from another device, or may be otherwise provided to a processor for analysis (including video compression, motion analysis, etc.).

Various motion artifacts may be detected and resolved based on a comparison of first frame 100-a and second frame 100-b. These motion artifacts may, for example, be described in the context of motion vectors as illustrated with respect to motion vector grid 105. For example, first motion vector 115 may be determined based at least in part on a comparison of pixel 110-a of first frame 100-a and pixel 110-c of second frame 100-b. In some cases, first motion vector 115 may illustrate aspects of a global motion vector as described further below. For example, at least some apparent motion between first frame 100-a and second frame 100-b may be based on motion of the camera (e.g., the viewpoint) rather than motion of any individual object. This global motion vector may be used to resolve or refine local motion estimates. As described further below, a global motion vector may be estimated and refined based on a multiple-pass (e.g., pyramidal) low resolution comparison of first frame 100-a and second frame 100-b. That is, first frame 100-a may be downscaled one or more times (e.g., such that a group of pixels 110 in first frame 100-a may correspond to a single pixel in the downsampled image). Second frame 100-b may be similarly downscaled. A comparison of the downsampled images may be used to estimate and iteratively refine a coarse global motion estimate.

In some cases, motion vector grid 105 may additionally contain artifacts representing local motion. For example, second motion vector 120 may incorporate the global motion described above (e.g., because of viewpoint shift) as well as local motion (e.g., based on the car 130 moving away from the house 125). For example, second motion vector 120 may be determined based at least in part on a comparison of pixel 110-b of first frame 100-a and pixel 110-d of second frame 100-b.

In some cases, determining the global and local motion vectors described above may involve a rigorous search process. For example, in order to detect the motion of the car, a theoretically simple (but computationally complex) method may involve searching across each pixel 110 of second frame 100-b for a suitable candidate pixel that corresponds to pixel 110-b. While this method may provide accurate results in some cases, the cost of the computations may be intractable. The described techniques provide for simplified motion estimation.

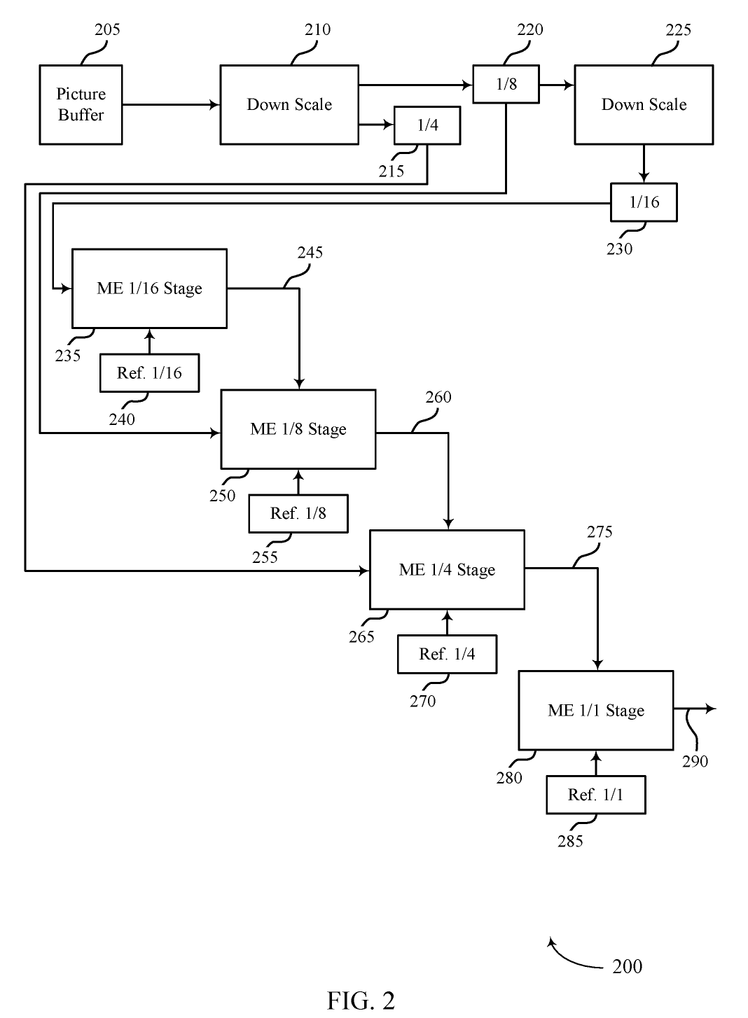

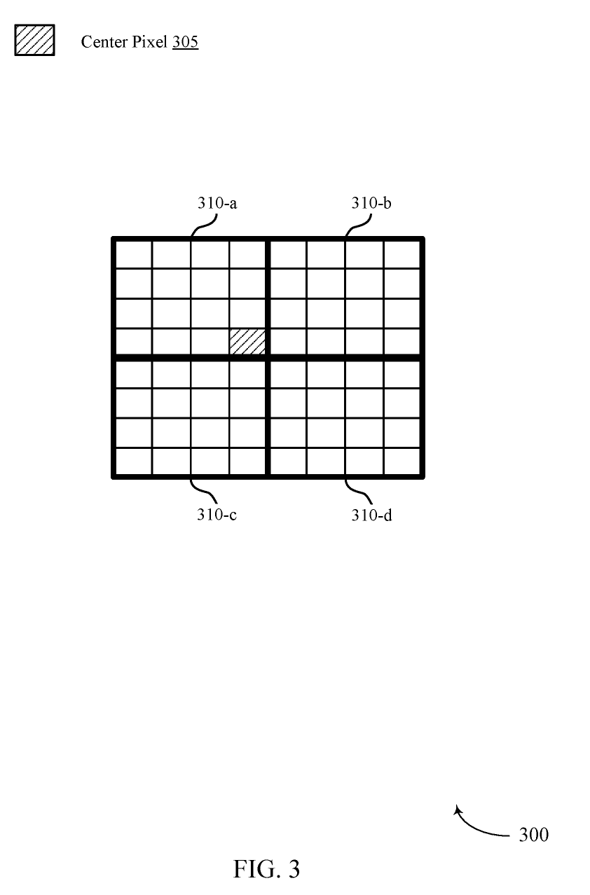

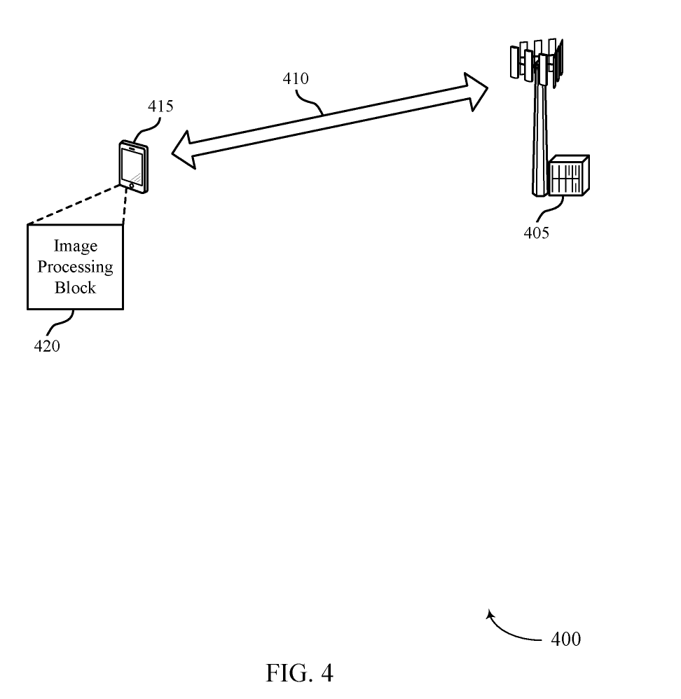

As described herein, a device may identify frames of a video frame sequence (e.g., first frame 100-a and second frame 100-b), each having a defined resolution (e.g., where the resolution may be defined by the number of pixels 110 in each frame 100). The device may downscale the frames to generate a plurality of downsampled images each having a resolution lower than the defined resolution (e.g., as described with reference to FIG. 2). The device may generate a respective histogram vector for each pixel of each downsampled image and each pixel of the original frames (e.g., as described with reference to FIG. 3). The device may determine a motion vector candidate based at least in part on the histogram vectors. The device may apply a filter to the motion vector candidates to determine a final motion vector (e.g., first motion vector 115, second motion vector 120, etc.) and output an indication of motion (e.g., motion vector grid 105) between the frames of the video frame sequence based at least in part on the final motion vector for each pixel of the second frame.

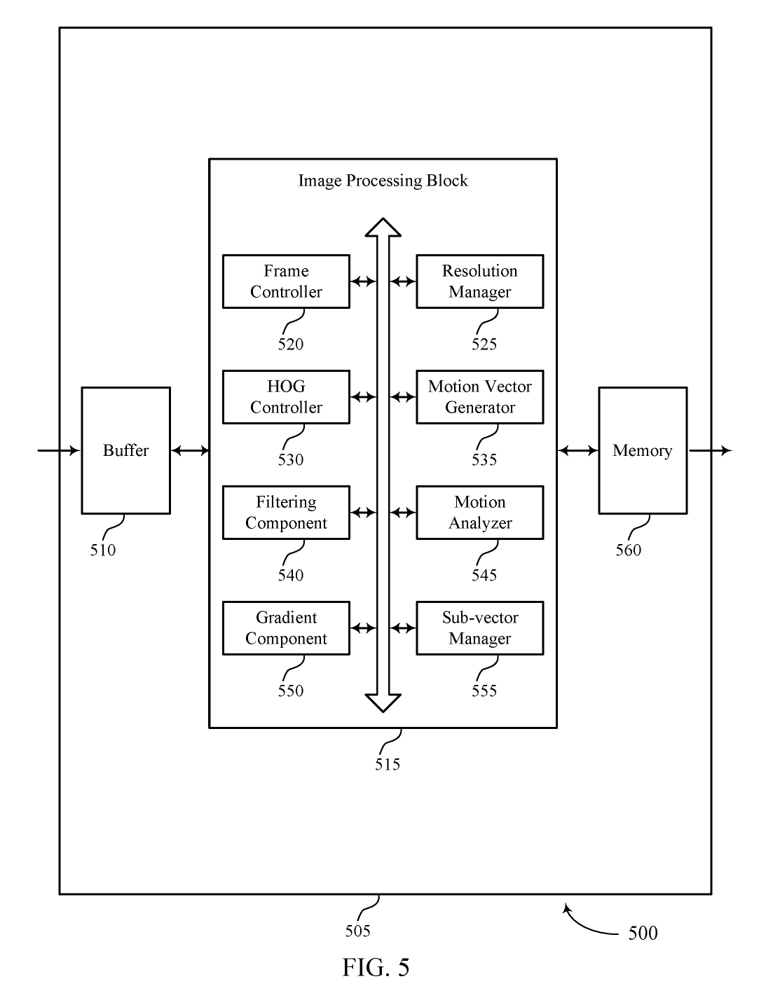

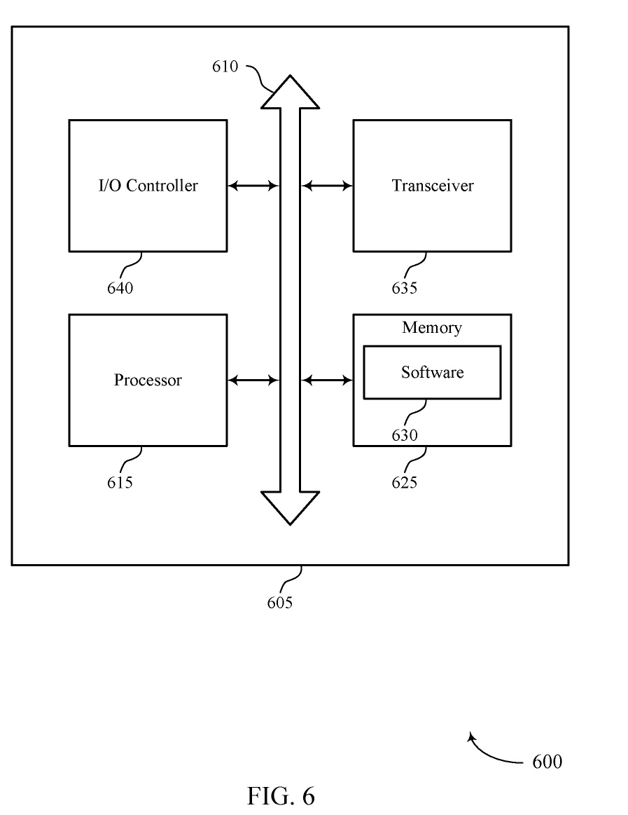

FIG. 2 illustrates an example of a process flow 200 that supports histogram of gradient based optical flow in accordance with various aspects of the present disclosure. In some examples, process flow 200 may implement aspects of features described with reference to FIGS. 1A, 1B, and 1C. For example, process flow 200 may be implemented by a device or components thereof described with reference to FIGS. 5 and 6.

At 205, a device may access (e.g., or receive) two or more frames from a picture buffer. In some cases, the picture buffer may store (e.g., temporarily) images retrieved from a system memory (e.g., or a transportable memory that is interoperable with the device such as a flash drive). Additionally or alternatively, the picture buffer may temporarily store images received from another device (e.g., via a wireless communication link). Each frame may have a defined resolution (e.g., 512 pixels by 512 pixels).

At 210, the device may downscale the two or more frames. For example, at 215 the downscaling may produce a first set of downsampled images (e.g., one for each of the two or more frames) having ¼ the resolution (e.g., 128 pixels by 128 pixels) of the original frames. Similarly, at 220 the downscaling may produce a second set of downsampled images (e.g., one for each of the two or more frames) having ⅛ the resolution (e.g., 64 pixels by 64 pixels) of the original frames. At 225, the device may downscale the second set of downsampled images to produce a third set of downsampled images at 230 (e.g., one for each of the two or more frames) having 1/16 the resolution (e.g., 32 pixels by 32 pixels) of the original frames. In some cases, the downscaling at 225 may be performed on the original frames or the ¼ resolution downsampled images (e.g., instead of the ⅛ resolution images). Additionally or alternatively, the downscaling at 210 and 225 may in some cases be performed by software executed over the same hardware (e.g., or by co-located hardware) such as a graphics processing unit (GPU).

The device may perform pyramidal feed-forward global motion estimation based on the sets of downsampled images. Though process flow 200 is described in the context of three downsampled images, it is to be understood that the described techniques may be extended to any suitable number of downsampled images. At 235, the device may access the 1/16 resolution representation of a current frame (e.g., second frame 100-b described with reference to FIG. 1B) and may access the 1/16 resolution representation of a reference frame (e.g., first frame 100-a described with reference to FIG. 1A.). For example, the low resolution current frame may be accessed from the output of the downscaling at 225 while the 1/16 resolution representation of the reference frame may be accessed at 240 (e.g., from a local buffer storing the results of a previous motion estimation). That is, in some cases the downscaled images of the current frame may be stored (e.g., in a local buffer) for use as a reference frame in a subsequent motion estimation (e.g., such that the downscaling at 210 and 225 may in some cases be performed on a single frame rather than two or more frames). At 235, the device may convert the 1/16 resolution downsampled images to the histogram of gradient domain (e.g., as described with reference to FIG. 3). The device may then determine a candidate coarse global motion vector for each pixel of the current downsampled image based on comparing histogram vectors for that pixel with histogram vectors for a given search range of pixels in the reference downsampled image.

For example, the device may apply a cost function to the histogram vectors within the search range as further described with reference to FIG. 3. Based on the processing at 235, the device may generate a set of motion vector candidates (e.g., two motion vector candidates) for each pixel, and may feed these candidates to a subsequent stage of the pyramidal analysis at 245. By way of example, a first motion vector candidate may be based on applying a 3-by-3 filter to motion vector candidates surrounding a given pixel, where the 3-by-3 filter sorts motion vector candidates for the 3-by-3 spatial region surrounding the given pixel and selects the median candidate as a first motion vector candidate. Similarly, a second motion vector candidate may be based on applying a 7-by-7 filter to motion vector candidates surrounding the given pixel, where the 7-by-7 filter sorts motion vector candidates for a subset of pixels in the 7-by-7 region surrounding the given pixel (e.g., for twelve of the forty-nine pixels) and selects the median candidate as a second motion vector candidate. For example, the median may be used to reduce the impact of noisy motion vector estimates (e.g., or may provide other similar benefits). It is to be noted that the filter sizes described here are included for the sake of illustration and are not limiting of scope.

At 250, the device may access the ⅛ resolution representation of the current frame and the ⅛ resolution representation of the reference frame. For example, the ⅛ resolution current frame may be accessed from the output of the downscaling at 210 while the ⅛ resolution representation of the reference frame may be accessed at 255 (e.g., from a local buffer storing the results of a previous motion estimation). At 250, the device may convert the ⅛ resolution downsampled images to the histogram of gradient domain (e.g., as described with reference to FIG. 3). The device may then apply one (or both) coarse global motion vector candidates received at 245 to each corresponding pixel of the ⅛ resolution downsampled images (e.g., where the corresponding pixels refer to a region, such as a 2 pixel by 2 pixel region, of the ⅛ resolution image that is contained within a single pixel of the 1/16 resolution image). That is, the device may search around the coarse global motion vector candidate(s) to determine one or more refined motion estimates. The device may refine the coarse global motion vector for each pixel of the current ⅛ downsampled image based on comparing histogram vectors for that pixel with histogram vectors for a given search range of pixels in the reference ⅛ downsampled image (e.g., where the search range may be determined based at least in part on the coarse global motion estimates received at 245). For example, the device may apply a cost function to the histogram vectors within the search range as further described with reference to FIG. 3. Based on the processing at 250, the device may generate a set of motion vector candidates (e.g., two motion vector candidates) for each pixel, and may feed these candidates to a subsequent stage of the pyramidal analysis at 260 (e.g., where the motion vector candidates for each pixel are determined based on the 3-by-3 and 7-by-7 filters described with reference to 245).

At 265, the device may access the ¼ resolution representation of the current frame and the ¼ resolution representation of the reference frame. For example, the ¼ resolution current frame may be accessed from the output of the downscaling at 210 while the ¼ resolution representation of the reference frame may be accessed at 270 (e.g., from a local buffer storing the results of a previous motion estimation). At 265, the device may convert the ¼ resolution downsampled images to the histogram of gradient domain (e.g., as described with reference to FIG. 3). The device may then apply one (or both) coarse global motion vector candidates received at 260 to each corresponding pixel of the ¼ resolution downsampled images (e.g., where the corresponding pixels refer to a region, such as a 2 pixel by 2 pixel region, of the ¼ resolution image that is contained within a single pixel of the ⅛ resolution image). That is, the device may search around the coarse global motion vector candidate(s) to refine the motion estimates. The device may refine the coarse global motion vector for each pixel of the current ¼ downsampled image based on comparing histogram vectors for that pixel with histogram vectors for a given search range of pixels in the reference ¼ downsampled image (e.g., where the search range may be determined based at least in part on the coarse global motion estimates received at 260). For example, the device may apply a cost function to the histogram vectors within the search range as further described with reference to FIG. 3. Based on the processing at 265, the device may generate a set of motion vector candidates (e.g., two motion vector candidates) for each pixel, and may feed the best candidate to a final stage of the pyramidal analysis at 275.

At 280, the device may access the full resolution representation of the current frame and the full resolution representation of the reference frame (e.g., at 285 from a local buffer storing the results of a previous motion estimation or from the picture buffer at 205). At 280, the device may convert the full resolution images to the histogram of gradient domain (e.g., as described with reference to FIG. 3). The device may then apply the global motion vector candidate received at 275 to each corresponding pixel of the full resolution downsampled images (e.g., where the corresponding pixels refer to a region, such as a 4 pixel by 4 pixel region, of the full resolution image that is contained within a single pixel of the ¼ resolution image). That is, the device may search around the refined global motion vector candidate to determine local motion information.

The device may refine the coarse global motion vector and determine the local motion information for each pixel of the current full resolution image based on comparing histogram vectors for that pixel with histogram vectors for a given search range of pixels in the reference full resolution image. For example, the device may apply a cost function to the histogram vectors within the search range as further described with reference to FIG. 3. Based on the processing at 280, the device may generate a final motion vector candidate at 290. The operations at 280 may allow for motion estimates to be obtained for small objects not captured in the low resolution analysis. Additionally or alternatively, the operations at 280 may allow the device to select a motion vector winner (e.g., based on a lowest cost metric) from a candidate pool. For example, the device may search around a set of candidates to find a minimum cost, where the search is based at least in part on one or more neighboring motion vectors (e.g., a motion vector for a pixel above the current pixel, a motion vector for a pixel to the left of the current pixel, etc.) as described further with reference to FIG. 3.

In some cases, the final motion vector candidates for each pixel of the full resolution image may be further filtered. For example, the device may determine a block variance metric (e.g., describing a variance between motion vectors for a given region of the full resolution image) and apply one of two or more filters to the region based at least in part on the block variance metric. By way of example, the device may use a small filter (e.g., a 3-by-3 adaptive median filter) for a high variance region (e.g., which may indicate a highly-textured portion of the image) and a large filter (e.g., a 5-by-5 adaptive median filter) for a low variance region (e.g., which may indicate a low-textured portion of the image). The operations of these filters may be analogous to those described above with reference to generating the set of motion vector candidates at each stage of the pyramidal feed forward global motion estimation. That is, the adaptive median filtering may serve to smooth the variance between motion vector estimates (e.g., which may be desirable in the case of some optical flow analysis).

FIG. 3 illustrates an example of a pixel array 300 that supports histogram of gradient based optical flow in accordance with various aspects of the present disclosure. For example, pixel array 300 may illustrate aspects of histogram of gradient based analysis described with reference to process flow 200.

For a given image (e.g., any of the downsampled images or full resolution images described above), a histogram vector may be determined for each pixel. That is, each pixel of each image may be an example of center pixel 305. Histogram vectors for pixels located near the edge of each image may be processed using analogous techniques (e.g., with smaller surrounding regions, using extrapolative or interpolative estimations, etc.). In accordance with the described techniques, a gradient may be computed for each pixel of each image. For example, the gradient may be computed based on applying Sobel filters (e.g., or analogous filters) to luma values of the pixelated images. For example, the Sobel filters may produce a horizontal gradient and a vertical gradient. The device may convert the horizontal gradient and vertical gradient (e.g., rectangular coordinates of the gradient) into polar coordinates (e.g., may obtain a gradient magnitude and orientation). As an example, a coordinate rotational digital computer (CORDIC) algorithm (e.g., or another hardware-friendly, scalable technique) may be used to achieve the rectangular to polar conversion.

Accordingly, each pixel of pixel array 300 may be associated with a respective gradient having a given orientation and magnitude. In accordance with the described techniques, a device may build a histogram vector for center pixel 305 based on the gradients for the pixels in a surrounding region (illustrated by pixel array 300). Pixel array 300 may be divided into four non-overlapping sectors (sector 310-a, sector 310-b, sector 310-c, and sector 310-d). While the surrounding region is shown as having a size of 8 pixels by 8 pixels, other sized surrounding regions are explicitly contemplated in accordance with the present disclosure. The gradients for the pixels within each sector 310 may be divided into a sub-vector of histograms. For example, nine histograms may be used for each sector 310, where each histogram corresponds to a given orientation. By way of example, a first histogram may correspond to a zero degree orientation while a second histogram may correspond to a forty degree orientation. Thus, a gradient for a given pixel in the sector 310 having an orientation of twenty degrees and a magnitude of two units would contribute one unit to the first histogram and one unit to the second histogram. Alternatively, a gradient for a given pixel in the sector 310 having an orientation of thirty degrees would contribute 1.5 units to the second histogram and 0.5 units to the first histogram. These numbers are included for the sake of explanation and are not limiting of scope. Following the generation of the sub-vector of histograms for each sector 310, the device may concatenate the sub-vectors to form a 36-bin histogram vector for center pixel 305.

In accordance with techniques described with reference to process flow 200, the device may determine one or more motion vector candidates for each pixel based at least in part on the histogram vectors. The use of histogram vectors may provide more insight for a given pixel (e.g., compared to the luma intensity of the pixel) because the histogram vectors include orientation information. By way of example, to determine (or refine) motion vector candidates for a given pixel such as center pixel 305, a device may compute and compare histogram vectors using a cost function such as:

Cost_{TME}=|HOGRef_{8×8}−HOGCur_{8×8}|+CLIP(TH1,k*(MV−MV_{left})+k(MV−MVₜₒₚ))

where

$$\vert {HOGRef}_{8 \times 8} - {HOGCur}_{8 \times 8} \vert = {\sum }_{p = 1 …64} {\sum }_{i = \{ 1 …36 \}} \vert {hog ( p , i )}_{ref} - {hog ( p , i )}_{cur} \vert$$

In these equations, p refers to a given pixel (e.g., a pixel within a given surrounding region), and i refers to a given bin index for the histogram vector of that pixel. MV refers to the motion vector candidate being analyzed, MV_{left} refers to the motion vector candidate of the pixel to the left and MVₜₒₚ refers to the motion vector candidate of the pixel above the current pixel. k refers to a configurable parameter which may be used to weight a smoothing penalty. That is, if the current motion vector candidate differs significantly from the motion vector candidate of the pixel to the left or the pixel above, a penalty may be applied to the cost function (where the penalty is weighted according to some parameter k). TH1 refers to a (configurable) threshold which limits the magnitude of the penalty (e.g., where the CLIP function indicates selecting limiting the penalty to be less than or equal to TH1).

Using these techniques, a device may determine and compare one or more cost functions for a given motion vector candidate for a pixel. By selecting a motion vector candidate associated with a lowest cost metric, the pyramidal feed forward global motion estimation described with reference to process flow 200 may iteratively approach a true motion estimate.

FIG. 4 illustrates an example of a wireless communications system 400 that supports compact models for object recognition in accordance with various aspects of the present disclosure. As illustrated, wireless communications system 400 includes a mobile device 415 in communication with a base station 405 (e.g., via wireless link 410). For example, wireless link 410 may be used to communicate data packets representing frames 100 as described with reference to FIG. 1A and FIG. 1B. Although illustrated as occurring between base station 405 and mobile device 415, it is to be understood that wireless link 410 may additionally or alternatively support communication between two mobile stations 415, two base stations 405, a mobile station 415 and an external server, etc.

Base station 405 may wirelessly communicate with the mobile devices 415 via one or more base station antennas. Wireless link 410 may include uplink transmissions from mobile device 415 to base station 405, or downlink transmissions, from base station 405 to mobile device 415. Base stations 405 in wireless communications system 400 may interface with a core network through backhaul links. Base stations 405 may also communicate with one another over backhaul links, either directly or indirectly. Base stations 405 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 400 may include base stations 405 of different types (e.g., macro or small cell base stations). The mobile devices 415 described herein may be able to communicate with various types of base stations 405 and network equipment including macro eNBs, small cell eNBs, gNBs, relay base stations, and the like.

Mobile devices 415 may be dispersed throughout wireless communications system 400, and each mobile device 415 may be stationary or mobile. A mobile device 415 may also be referred to as a user equipment (UE), a wireless device, a remote device, a handheld device, or a subscriber device, or some other suitable terminology, where the “device” may also be referred to as a unit, a station, a terminal, or a client. A mobile device 415 may be a personal electronic device such as a cellular phone, a personal digital assistant (PDA), a tablet computer, a laptop computer, or a personal computer. In some examples, a mobile device 415 may also refer to a wireless local loop (WLL) station, an Internet of Things (IoT) device, an Internet of Everything (IoE) device, a machine type communication (MTC) device, or the like, which may be implemented in various articles such as appliances, vehicles, meters, or the like. or some other suitable terminology. Mobile device 415 may include image processing block 420, which may be an example of image processing block 515 described with reference to FIG. 5. Mobile device 415 may thus support robust motion analysis in the context of a computationally conservative framework.

FIG. 5 shows a block diagram 500 of a device 505 that supports histogram of gradient based optical flow in accordance with aspects of the present disclosure. Device 505 may be support aspects of operations described with reference to FIG. 1A, FIG. 1B, FIG. 1C, FIG. 2, FIG. 3, and FIG. 4. Device 505 may include buffer 510, image processing block 515, and memory 560. Image processing block 515 may also include frame controller 520, resolution manager 525, histogram of gradient (HOG) controller 530, motion vector generator 535, filtering component 540, motion analyzer 545, gradient component 550, and sub-vector manager 555. Each of these components may be in communication with one another (e.g., via one or more buses).

Buffer 510 may store information such as video streams, frames, portions thereof, etc. For example, buffer 510 may be an example of random access memory (RAM), dynamic RAM (DRAM), static RAM (SRAM), or some other short-term memory. Information may be passed from buffer 510 to other components of device 505.

Image processing block 515 may be an example of aspects of the processor 615 described with reference to FIG. 6. Image processing block 515 and/or at least some of its various sub-components may be implemented in hardware, software executed by a processor, firmware, or any combination thereof. If implemented in software executed by a processor, the functions of the image processing block 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, GPU, or any combination thereof designed to perform the functions described in the present disclosure.

Image processing block 515 and/or at least some of its various sub-components may be physically located at various positions, including being distributed such that portions of functions are implemented at different physical locations by one or more physical devices. In some examples, image processing block 515 and/or at least some of its various sub-components may be a separate and distinct component in accordance with various aspects of the present disclosure. In other examples, image processing block 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Frame controller 520 may identify a first frame of a video frame sequence and a second frame of the video frame sequence, the first and second frame each having a defined resolution.

Resolution manager 525 may downscale the first frame and the second frame to generate a set of downsampled images each having a resolution lower than the defined resolution. For example, resolution manager 525 may downscale the first frame to generate a first downsampled image having a first resolution (e.g., ¼ of the defined resolution, ⅛ of the defined resolution) and a second downsampled image having a second resolution that is lower than the first resolution (e.g., ½ of the first resolution). Resolution manager 525 may downscale the second frame to generate a third downsampled image having the first resolution and a fourth downsampled image having the second resolution.

HOG controller 530 may generate a respective histogram vector for each pixel of each downsampled image and each pixel of the first frame and the second frame. In some cases, HOG controller 530 may concatenate the sub-vectors of histograms to generate the histogram vector (e.g., where the sub-vectors of histograms are generated as described with reference to FIG. 3).

Motion vector generator 535 may determine a motion vector candidate for each pixel of the second frame based on the histogram vectors. Motion vector generator 535 may determine a coarse global motion candidate for a given pixel of the fourth downsampled image based on comparing the histogram vector for the given pixel and the histogram vector for at least one pixel in the second downsampled image. Motion vector generator 535 may apply the global motion candidate for the given pixel of the fourth downsampled image to a corresponding set of pixels of the third downsampled image. Motion vector generator 535 may refine the coarse global motion candidate to generate a respective fine global motion candidate for each pixel of the corresponding set of pixels based at least in part on the histogram vectors for the third downsampled image and the histogram vectors for the first downsampled image. Motion vector generator 535 may reduce a variance for the fine global motion candidates of the corresponding set of pixels based at least in part on applying a respective cost function to each fine global motion candidate, wherein the cost function comprises a clipping function that limits the variance.

Filtering component 540 may apply a filter to the motion vector candidates of the second frame to determine a final motion vector for each pixel of the second frame. Filtering component 540 may identify a block variance metric for a region of the second frame surrounding the pixel. Filtering component 540 may select a first median-based filter or a second median-based filter that is larger than the first median-based filter based on the block variance metric. Filtering component 540 may apply the first median-based filter to the motion vector candidates or the second median-based filter to the motion vector candidates. Filtering component 540 may compare the block variance metric to a threshold and select the first median-based filter when the block variance metric is greater than the threshold or select the second median-based filter when the block variance metric is less than the threshold.

Motion analyzer 545 may output an indication of motion between the first frame and the second frame based on the final motion vector for each pixel of the second frame.

Gradient component 550 may determine a respective gradient for each pixel of each downsampled image and each pixel of the first frame and the second frame. In some cases, determining the respective gradient for each pixel includes computing a horizontal gradient and a vertical gradient for each pixel. Gradient component 550 may determine a magnitude and an orientation for the respective gradient based on the horizontal gradient and the vertical gradient.

Sub-vector manager 555 may identify, for each pixel of each downsampled image and each pixel of the first frame and the second frame, a surrounding region including a set of neighboring pixels. Sub-vector manager 555 may divide the surrounding region into a set of non-overlapping sectors each including a respective subset of the set of neighboring pixels. Sub-vector manager 555 may compute a sub-vector of histograms for each sector of the set of non-overlapping sectors based on the gradients for the respective subset of the set of neighboring pixels. Sub-vector manager 555 may identify a nominal orientation associated with each histogram, compare each respective gradient to the nominal orientation of at least one histogram, and apportion each respective gradient into at least one histogram based at least in part on the magnitude of the respective gradient and the comparison.

Memory 560 may store information (e.g., motion estimation information) generated by other components of the device such as image processing block 515. In some examples, the memory 560 may be collocated with buffer 510. Memory 560 may comprise one or more computer-readable storage media. Examples of memory 560 include, but are not limited to, a RAM, SRAM, DRAM, a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor.

FIG. 6 shows a block diagram 600 including a device 605 that supports histogram of gradient based optical flow in accordance with aspects of the present disclosure. Device 605 may be an example of or include the components of mobile device 415 or a device 505 as described above, e.g., with reference to FIGS. 4 and 5. Device 605 may in some cases include components for bi-directional voice and data communications (e.g., may be an example of a wireless device). Device 605 may include processor 615, memory 625, software 630, transceiver 635, and I/O controller 640. These components may be in electronic communication via one or more buses (e.g., bus 610).

Processor 615 may include an intelligent hardware device, (e.g., a general-purpose processor, a DSP, a central processing unit (CPU), a GPU, a microcontroller, an ASIC, an FPGA, a programmable logic device, a discrete gate or transistor logic component, a discrete hardware component, or any combination thereof). In some cases, processor 615 may be configured to operate a memory array using a memory controller. In other cases, a memory controller may be integrated into processor 615. Processor 615 may be configured to execute computer-readable instructions stored in a memory to perform various functions (e.g., functions or tasks supporting histogram of gradient based optical flow). Processor 615 may be an example of image processing block 515.

Memory 625 may include RAM and ROM. The memory 625 may store computer-readable, computer-executable software 630 including instructions that, when executed, cause the processor to perform various functions described herein. In some cases, the memory 625 may contain, among other things, a basic input/output system (BIOS) which may control basic hardware or software operation such as the interaction with peripheral components or devices.

Software 630 may include code to implement aspects of the present disclosure, including code to support histogram of gradient based optical flow. Software 630 may be stored in a non-transitory computer-readable medium such as system memory or other memory. In some cases, the software 630 may not be directly executable by the processor but may cause a computer (e.g., when compiled and executed) to perform functions described herein.

Transceiver 635 may optionally communicate bi-directionally, via one or more antennas, wired, or wireless links as described above. For example, the transceiver 635 may represent a wireless transceiver and may communicate bi-directionally with another wireless transceiver. The transceiver 635 may also include a modem to modulate the packets and provide the modulated packets to the antennas for transmission, and to demodulate packets received from the antennas.

I/O controller 640 may manage input and output signals for device 605. I/O controller 640 may also manage peripherals not integrated into device 605. In some cases, I/O controller 640 may represent a physical connection or port to an external peripheral. In some cases, I/O controller 640 may utilize an operating system such as iOS®, ANDROID®, MS-DOS®, MS-WINDOWS®, OS/2®, UNIX®, LINUX®, or another known operating system. In other cases, I/O controller 640 may represent or interact with a modem, a keyboard, a mouse, a touchscreen, or a similar device. In some cases, I/O controller 640 may be implemented as part of a processor. In some cases, a user may interact with device 605 via I/O controller 640 or via hardware components controlled by I/O controller 640.

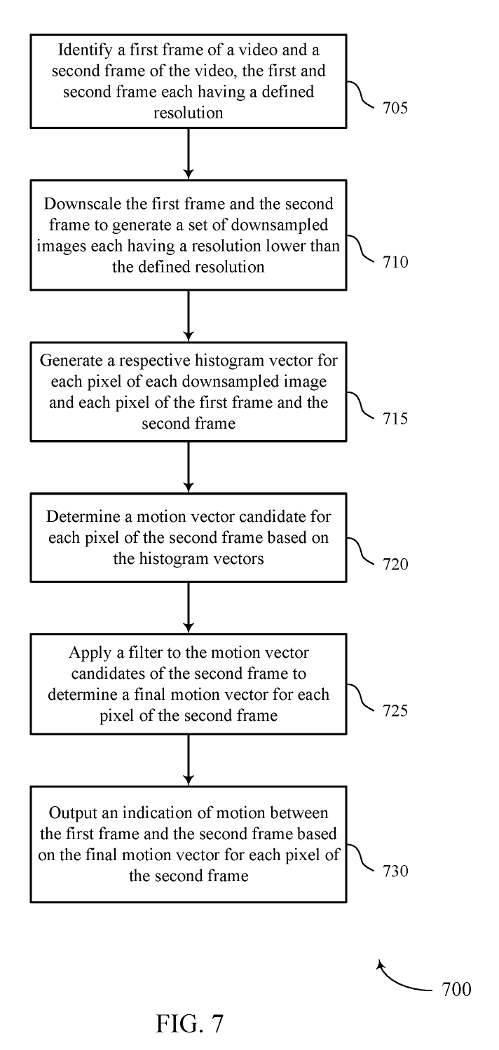

FIG. 7 shows a flowchart illustrating a method 700 for histogram of gradient based optical flow in accordance with aspects of the present disclosure. The operations of method 700 may be implemented by a device or its components as described herein. For example, the operations of method 700 may be performed by a processor, such as image processing block 515 as described with reference to FIG. 5. In some examples, a device may execute a set of codes to control the functional elements of the device to perform the functions described below. Additionally or alternatively, the device may perform aspects of the functions described below using special-purpose hardware.

At 705 the device may identify a first frame of a video frame sequence and a second frame of the video frame sequence, the first and second frame each having a defined resolution. The operations of 705 may be performed according to the methods described herein. In certain examples, aspects of the operations of 705 may be performed by a frame controller as described with reference to FIG. 5.

At 710 the device may downscale the first frame and the second frame to generate a set of downsampled images each having a resolution lower than the defined resolution. The operations of 710 may be performed according to the methods described herein. In certain examples, aspects of the operations of 710 may be performed by a resolution manager as described with reference to FIG. 5.

At 715 the device may generate a respective histogram vector for each pixel of each downsampled image and each pixel of the first frame and the second frame. The operations of 715 may be performed according to the methods described herein. In certain examples, aspects of the operations of 715 may be performed by a HOG controller as described with reference to FIG. 5.

At 720 the device may determine a motion vector candidate for each pixel of the second frame based at least in part on the histogram vectors. The operations of 720 may be performed according to the methods described herein. In certain examples, aspects of the operations of 720 may be performed by a motion vector generator as described with reference to FIG. 5.

At 725 the device may apply a filter to the motion vector candidates of the second frame to determine a final motion vector for each pixel of the second frame. The operations of 725 may be performed according to the methods described herein. In certain examples, aspects of the operations of 725 may be performed by a filtering component as described with reference to FIG. 5.

At 730 the device may output an indication of motion between the first frame and the second frame based at least in part on the final motion vector for each pixel of the second frame. The operations of 730 may be performed according to the methods described herein. In certain examples, aspects of the operations of 730 may be performed by a motion analyzer as described with reference to FIG. 5.

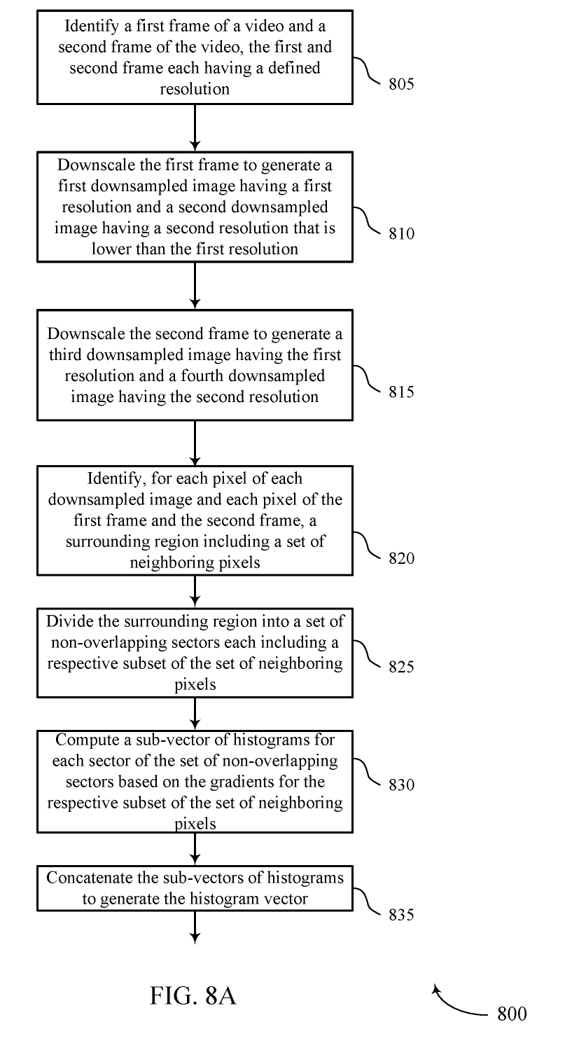

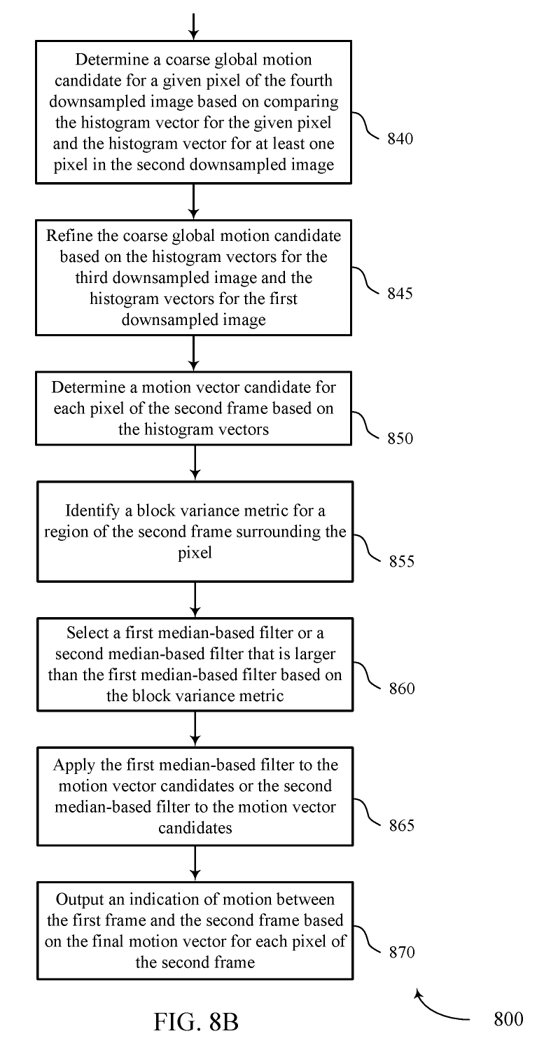

FIGS. 8A and 8B show a flowchart illustrating a method 800 for histogram of gradient based optical flow in accordance with aspects of the present disclosure. The operations of method 800 may be implemented by a device or its components as described herein. For example, the operations of method 800 may be performed by a processor, such as image processing block 515 as described with reference to FIG. 5. In some examples, a device may execute a set of codes to control the functional elements of the device to perform the functions described below. Additionally or alternatively, the device may perform aspects of the functions described below using special-purpose hardware.

At 805 the device may identify a first frame of a video frame sequence and a second frame of the video frame sequence, the first and second frame each having a defined resolution. The operations of 805 may be performed according to the methods described herein. In certain examples, aspects of the operations of 805 may be performed by a frame controller as described with reference to FIG. 5.

At 810 the device may downscale the first frame to generate a first downsampled image having a first resolution and a second downsampled image having a second resolution that is lower than the first resolution. The operations of 810 may be performed according to the methods described herein. In certain examples, aspects of the operations of 810 may be performed by a resolution manager as described with reference to FIG. 5.

At 815 the device may downscale the second frame to generate a third downsampled image having the first resolution and a fourth downsampled image having the second resolution. The operations of 815 may be performed according to the methods described herein. In certain examples, aspects of the operations of 815 may be performed by a resolution manager as described with reference to FIG. 5.

At 820 the device may identify, for each pixel of each downsampled image and each pixel of the first frame and the second frame, a surrounding region comprising a set of neighboring pixels. The operations of 820 may be performed according to the methods described herein. In certain examples, aspects of the operations of 820 may be performed by a sub-vector manager as described with reference to FIG. 5.

At 825 the device may divide the surrounding region into a set of non-overlapping sectors each comprising a respective subset of the set of neighboring pixels. The operations of 825 may be performed according to the methods described herein. In certain examples, aspects of the operations of 825 may be performed by a sub-vector manager as described with reference to FIG. 5.

At 830 the device may compute a sub-vector of histograms for each sector of the set of non-overlapping sectors based at least in part on the gradients for the respective subset of the set of neighboring pixels. The operations of 830 may be performed according to the methods described herein. In certain examples, aspects of the operations of 830 may be performed by a sub-vector manager as described with reference to FIG. 5.

At 835 the device may concatenate the sub-vectors of histograms to generate the histogram vector. The operations of 835 may be performed according to the methods described herein. In certain examples, aspects of the operations of 835 may be performed by a HOG controller as described with reference to FIG. 5.

At 840 the device may determine a coarse global motion candidate for a given pixel of the fourth downsampled image based at least in part on comparing the histogram vector for the given pixel and the histogram vector for at least one pixel in the second downsampled image. The operations of 840 may be performed according to the methods described herein. In certain examples, aspects of the operations of 840 may be performed by a motion vector generator as described with reference to FIG. 5.

At 845 the device may refine the coarse global motion candidate based at least in part on the histogram vectors for the third downsampled image and the histogram vectors for the first downsampled image. The operations of 845 may be performed according to the methods described herein. In certain examples, aspects of the operations of 845 may be performed by a motion vector generator as described with reference to FIG. 5.

At 850 the device may determine a motion vector candidate for each pixel of the second frame based at least in part on the histogram vectors. The operations of 850 may be performed according to the methods described herein. In certain examples, aspects of the operations of 850 may be performed by a motion vector generator as described with reference to FIG. 5.

At 855 the device may identify a block variance metric for a region of the second frame surrounding the pixel. The operations of 855 may be performed according to the methods described herein. In certain examples, aspects of the operations of 855 may be performed by a filtering component as described with reference to FIG. 5.

At 860 the device may select a first median-based filter or a second median-based filter that is larger than the first median-based filter based at least in part on the block variance metric. The operations of 860 may be performed according to the methods described herein. In certain examples, aspects of the operations of 860 may be performed by a filtering component as described with reference to FIG. 5.

At 865 the device may apply the first median-based filter to the motion vector candidates or the second median-based filter to the motion vector candidates. The operations of 865 may be performed according to the methods described herein. In certain examples, aspects of the operations of 865 may be performed by a filtering component as described with reference to FIG. 5.

At 870 the device may output an indication of motion between the first frame and the second frame based at least in part on the final motion vector for each pixel of the second frame. The operations of 870 may be performed according to the methods described herein. In certain examples, aspects of the operations of 870 may be performed by a motion analyzer as described with reference to FIG. 5.

It should be noted that the methods described above describe possible implementations, and that the operations and the steps may be rearranged or otherwise modified and that other implementations are possible. Further, aspects from two or more of the methods may be combined. In some cases, one or more operations described with reference to FIGS. 8A and 8B may be omitted or adjusted without deviating from the scope of the present disclosure. Thus the methods described above are included for the sake of illustration and explanation and are not limiting of scope.

The various illustrative blocks and modules described in connection with the disclosure herein may be implemented or performed with a general-purpose processor, a DSP, an ASIC, a FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, EEPROM, flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for motion analysis, comprising:
a processor;
memory in electronic communication with the processor; and
instructions stored in the memory and executable by the processor to cause the apparatus to:
identify a first frame of a video frame sequence and a second frame of the video frame sequence, the first and second frame each having a defined resolution;
downscale the first frame and the second frame to generate a plurality of downsampled images each having a resolution lower than the defined resolution;
generate a respective histogram vector for each pixel of each downsampled image and each pixel of the first frame and the second frame;
determine a motion vector candidate for each pixel of the second frame based at least in part on the histogram vectors;
apply a filter to the motion vector candidates of the second frame to determine a final motion vector for each pixel of the second frame; and
output an indication of motion between the first frame and the second frame based at least in part on the final motion vector for each pixel of the second frame.

2. The apparatus of claim 1, wherein the instructions to downscale the first frame and the second frame to generate the plurality of downsampled images are executable by the processor to cause the apparatus to:
downscale the first frame to generate a first downsampled image having a first resolution and a second downsampled image having a second resolution that is lower than the first resolution; and
downscale the second frame to generate a third downsampled image having the first resolution and a fourth downsampled image having the second resolution.

3. The apparatus of claim 2, wherein the instructions are further executable by the processor to cause the apparatus to:
determine a coarse global motion candidate for a given pixel of the fourth downsampled image based at least in part on comparing the histogram vector for the given pixel and the histogram vector for at least one pixel in the second downsampled image.

4. The apparatus of claim 3, wherein the instructions are further executable by the processor to cause the apparatus to:
apply the global motion candidate for the given pixel of the fourth downsampled image to a corresponding set of pixels of the third downsampled image; and
refine the coarse global motion candidate to generate a respective fine global motion candidate for each pixel of the corresponding set of pixels based at least in part on the histogram vectors for the third downsampled image and the histogram vectors for the first downsampled image.

5. The apparatus of claim 4, wherein the instructions to refine the coarse global motion candidate are executable by the processor to cause the apparatus to:
reduce a variance for the fine global motion candidates of the corresponding set of pixels based at least in part on applying a respective cost function to each fine global motion candidate, wherein the cost function comprises a clipping function that limits the variance.

6. The apparatus of claim 1, wherein the instructions to generate the respective histogram vector for each pixel of each downsampled image and each pixel of the first frame and the second frame are executable by the processor to cause the apparatus to:
determine a respective gradient for each pixel of each downsampled image and each pixel of the first frame and the second frame;
identify, for each pixel of each downsampled image and each pixel of the first frame and the second frame, a surrounding region comprising a plurality of neighboring pixels;
divide the surrounding region into a plurality of non-overlapping sectors each comprising a respective subset of the plurality of neighboring pixels;
compute a sub-vector of histograms for each sector of the plurality of non-overlapping sectors based at least in part on the gradients for the respective subset of the plurality of neighboring pixels; and
concatenate the sub-vectors of histograms to generate the histogram vector.

7. The apparatus of claim 6, wherein the instructions to determine the respective gradient for each pixel are executable by the processor to cause the apparatus to:
compute a horizontal gradient and a vertical gradient for each pixel; and
determine a magnitude and an orientation for the respective gradient based at least in part on the horizontal gradient and the vertical gradient.

8. The apparatus of claim 7, wherein the instructions to compute the sub-vector of histograms are executable by the processor to cause the apparatus to:
identify a nominal orientation associated with each histogram;
compare each respective gradient to the nominal orientation of at least one histogram; and
apportion each respective gradient into at least one histogram based at least in part on the magnitude of the respective gradient and the comparison.

9. The apparatus of claim 1, wherein the instructions to apply the filter to the motion vector candidates of the second frame to determine the final motion vector for each pixel are executable by the processor to cause the apparatus to:
identify a block variance metric for a region of the second frame surrounding the pixel;
select a first median-based filter or a second median-based filter that is larger than the first median-based filter based at least in part on the block variance metric; and
apply the first median-based filter to the motion vector candidates or the second median-based filter to the motion vector candidates.

10. The apparatus of claim 9, wherein the instructions to select the first median-based filter or the second median-based filter are executable by the processor to cause the apparatus to:
compare the block variance metric to a threshold; and
select the first median-based filter when the block variance metric is greater than the threshold or select the second median-based filter when the block variance metric is less than the threshold.

11. A method for motion analysis, comprising:
identifying a first frame of a video frame sequence and a second frame of the video frame sequence, the first and second frame each having a defined resolution;
downscaling the first frame and the second frame to generate a plurality of downsampled images each having a resolution lower than the defined resolution;
generating a respective histogram vector for each pixel of each downsampled image and each pixel of the first frame and the second frame;
determining a motion vector candidate for each pixel of the second frame based at least in part on the histogram vectors;
applying a filter to the motion vector candidates of the second frame to determine a final motion vector for each pixel of the second frame; and
outputting an indication of motion between the first frame and the second frame based at least in part on the final motion vector for each pixel of the second frame.

12. The method of claim 11, wherein downscaling the first frame and the second frame to generate the plurality of downsampled images comprises:
downscaling the first frame to generate a first downsampled image having a first resolution and a second downsampled image having a second resolution that is lower than the first resolution; and
downscaling the second frame to generate a third downsampled image having the first resolution and a fourth downsampled image having the second resolution.

13. The method of claim 12, further comprising:
determining a coarse global motion candidate for a given pixel of the fourth downsampled image based at least in part on comparing the histogram vector for the given pixel and the histogram vector for at least one pixel in the second downsampled image.

14. The method of claim 13, further comprising:
applying the global motion candidate for the given pixel of the fourth downsampled image to a corresponding set of pixels of the third downsampled image; and
refining the coarse global motion candidate to generate a respective fine global motion candidate for each pixel of the corresponding set of pixels based at least in part on the histogram vectors for the third downsampled image and the histogram vectors for the first downsampled image.

15. The method of claim 11, wherein generating the respective histogram vector for each pixel of each downsampled image and each pixel of the first frame and the second frame comprises:
determining a respective gradient for each pixel of each downsampled image and each pixel of the first frame and the second frame;
identifying, for each pixel of each downsampled image and each pixel of the first frame and the second frame, a surrounding region comprising a plurality of neighboring pixels;
dividing the surrounding region into a plurality of non-overlapping sectors each comprising a respective subset of the plurality of neighboring pixels;
computing a sub-vector of histograms for each sector of the plurality of non-overlapping sectors based at least in part on the gradients for the respective subset of the plurality of neighboring pixels; and
concatenating the sub-vectors of histograms to generate the histogram vector.

16. The method of claim 11, wherein applying the filter to the motion vector candidates of the second frame to determine the final motion vector for each pixel comprises:
identifying a block variance metric for a region of the second frame surrounding the pixel;
selecting a first median-based filter or a second median-based filter that is larger than the first median-based filter based at least in part on the block variance metric; and
applying the first median-based filter to the motion vector candidates or the second median-based filter to the motion vector candidates.

17. A non-transitory computer-readable medium storing code for motion analysis, the code comprising instructions executable by a processor to:
identify a first frame of a video frame sequence and a second frame of the video frame sequence, the first and second frame each having a defined resolution;
downscale the first frame and the second frame to generate a plurality of downsampled images each having a resolution lower than the defined resolution;
generate a respective histogram vector for each pixel of each downsampled image and each pixel of the first frame and the second frame;
determine a motion vector candidate for each pixel of the second frame based at least in part on the histogram vectors;
apply a filter to the motion vector candidates of the second frame to determine a final motion vector for each pixel of the second frame; and
output an indication of motion between the first frame and the second frame based at least in part on the final motion vector for each pixel of the second frame.

18. The non-transitory computer-readable medium of claim 17, wherein the instructions to downscale the first frame and the second frame to generate the plurality of downsampled images are executable by the processor to:
downscale the first frame to generate a first downsampled image having a first resolution and a second downsampled image having a second resolution that is lower than the first resolution; and
downscale the second frame to generate a third downsampled image having the first resolution and a fourth downsampled image having the second resolution.

19. The non-transitory computer-readable medium of claim 17, wherein the instructions to generate the respective histogram vector for each pixel of each downsampled image and each pixel of the first frame and the second frame are executable by the processor to:
determine a respective gradient for each pixel of each downsampled image and each pixel of the first frame and the second frame;
identify, for each pixel of each downsampled image and each pixel of the first frame and the second frame, a surrounding region comprising a plurality of neighboring pixels;
divide the surrounding region into a plurality of non-overlapping sectors each comprising a respective subset of the plurality of neighboring pixels;
compute a sub-vector of histograms for each sector of the plurality of non-overlapping sectors based at least in part on the gradients for the respective subset of the plurality of neighboring pixels; and
concatenate the sub-vectors of histograms to generate the histogram vector.

20. The non-transitory computer-readable medium of claim 17, wherein the instructions to apply the filter to the motion vector candidates of the second frame to determine the final motion vector for each pixel are executable by the processor to:
identify a block variance metric for a region of the second frame surrounding the pixel;
select a first median-based filter or a second median-based filter that is larger than the first median-based filter based at least in part on the block variance metric; and
apply the first median-based filter to the motion vector candidates or the second median-based filter to the motion vector candidates.
